(19) United States
(12) Patent Application Publication
(10) Pub. No.: US 2018/0080640 A1
(43) Pub. Date: Mar. 22, 2018

(54) LIGHTING FIXTURES FOR INTERNALLY-LIT OR BACK-LIT SIGNS

(71) Applicant: Mansen WAY, Corydon, IN (US)

(72) Inventor: Mansen WAY, Corydon, IN (US)

(21) Appl. No.: 15/568,717

(22) PCT Filed: Apr. 25, 2016
(86) PCT No.: PCT/US2016/029266

§ 371 Date: Oct. 23, 2017

Related U.S. Application Data
(60) Provisional application No. 62/151,942, filed on Apr. 23, 2015.

(51) Int. Cl. F21V 21/26; F21V 23/00; F21V 7/00; F21V 23/02

(52) U.S. Cl. CPC F21V 21/26; F21V 23/003; F21Y 2115/10; F21V 7/00; F21V 23/02; F21V 23/002

(57) ABSTRACT

One or more lighting devices are disclosed. The lighting devices may be designed for back-lit or internally-lit signs. The lighting devices have a body segment with one or more hollow portions and a first and second arm, each having flanges extending from the center portion of each arm. One or more lighting components are mounted on the center portion of the first and/or second arms. The first and second arms are pivotally attached to the body segment so the arms can be opened (perpendicular) or closed (parallel) with respect to the body segment.

### CROSS-REFERENCE TO RELATED APPLICATIONS

This application claims the benefit of priority to U.S. provisional patent application No. 62/151,942, filed on Apr. 23, 2015, now pending, the disclosure of which is hereby incorporated by reference.

### FIELD OF THE DISCLOSURE

This disclosure relates to lighting fixtures for internally-lit or back-lit signs, for example, lighting fixtures that can be used to retrofit fluorescently-lit signs.

### BACKGROUND OF THE DISCLOSURE

Internally-lit or back-lit signs typically have a housing with one or more electric lighting fixtures for supporting and energizing gas-discharge electric lamps (such as neon or fluorescent tube lamps) and associated electrical wiring to conduct electricity from the lighting fixtures to a power source. At least one side of the housing supports a display sheet (such as a rigid, semi-rigid, or flexible sheet made of cloth, paper, glass, or polymer) that is at least partially translucent. The sheet may include lettering, symbols, artwork, or other aesthetically pleasing features. Light from the lamps projects through the display sheet to illuminate, for example, the lettering or artwork on the sheet.

Recently, there have been efforts to utilize light emitting diodes (LEDs) instead of gas-discharge electric lamps. LEDs require less power, but such efforts involve the use of a plurality of spaced LEDs to provide the necessary candlepower for adequate illumination. One undesirable result of recent efforts is that the LEDs produce bright spots in the sheet even when diffuser material is placed between the LEDs and the sheet.

Furthermore, current LED lighting fixtures have numerous deficiencies such as being cumbersome in design, requiring considerable maintenance, and subject to failure, and are relatively expensive and complex to manufacture.

### BRIEF SUMMARY OF THE DISCLOSURE

The present disclosure describes lighting fixtures that can be used to retrofit existing internally-lit or back-lit signs, which were originally manufactured for supporting and energizing gas-discharge lamps such as high-output fluorescent or neon tube lamps. Optionally, the lighting fixture of the present disclosure can be used in the production of new internally-lit or back-lit signs that are equipped for low-voltage lighting, substantially without modifying the mechanical or structural features of the signs, which may have originally been designed to be internally lit by one or more higher-voltage fluorescent or neon tube lamps. Embodiments of the present disclosure may be collapsible and configured in multiple variations having multiple different sizes.

One embodiment of the present invention is a lighting device comprising a body segment having a first end a second end. The body segment has one or more hollow portions in communication with the first end and/or second end. The hollow portion may extend from the first end of the body segment to the second end of the body segment. The body segment may have an aperture configured to permit electrical cables to enter the body segment.

The lighting device further comprises a first arm having a center portion and one or more flanges extending from the center portion. The lighting device further comprises a second arm having a center portion and one or more flanges extending from the center portion. The flanges may be configured to reflect light emitted from the one or more lighting components.

The first arm and second arm are pivotally attached to the body segment such that the first arm and second arm can be positioned to be substantially perpendicular to the body segment and substantially parallel to the body segment. The first arm and second arm may be pivotally attached using a pin or hinge. The first arm and second arm may be pivotally attached to the body segment at, respectively, a first and second pivot point. The central portion of the first arm may extend past the first pivot point and the central portion of the second arm extends past the second pivot point. The one or more hollow portions may be substantially covered by the central portion of the first arm that extends past the first pivot point and/or the central portion of the second arm that extends past the second pivot point. The first arm and second arm may be biased away from being substantially parallel to the body segment.

The lighting device further comprises one or more lighting components mounted on the center portion of the first arm and/or the center portion of the second arm. One or more power components may be positioned within the one or more hollow portions of the body segment such that the power components are in electrical and/or selective communication with the one or more lighting components. The one or more power components may be LED drivers.

In one embodiment, the first arm has a first cross-member and the second arm has a second cross-member. The first cross-member may be pivotally attached to the central portion of the first arm and the second cross-member may be pivotally attached to the central portion of the second arm. The first cross-member and second-cross member may be biased to be perpendicular to the central portion of the first arm and second arm.

### DESCRIPTION OF THE DRAWINGS

For a fuller understanding of the nature and objects of the disclosure, reference should be made to the following detailed description taken in conjunction with the accompanying drawings, in which:

FIG. 1 is a photograph of a first embodiment, wherein the lighting components are energized;

FIG. 2 is a photograph of the first embodiment, wherein the lighting components are not energized;

FIG. 3 is a photograph of the first embodiment, wherein the first and second arms are collapsed to be substantially parallel to the body segment;

FIG. 4 is a photograph of the first embodiment, wherein the first and second arms are collapsed to be substantially parallel to the body segment;

FIG. 5 is a photograph of a second embodiment, wherein the lighting components are energized; and

FIG. 6 is a photograph of the second embodiment, wherein the first and second arms are collapsed to be substantially parallel to the body segment.

### DETAILED DESCRIPTION OF THE DISCLOSURE

One embodiment of the present disclosure may be described as a lighting device or lighting fixture. The term lighting device and lighting fixture may be used interchangeably throughout this disclosure.

The lighting device may comprise a body segment. The body segment may have a first end and a second end. The body segment may be constructed from a stiff material, such as metal or plastic. The body segment may be rectangular, square, or cylindrical. The body segment may be substantially straight or curved throughout the entire body segment. The body segment may be substantially straight in some portions and curved in others. The body segment may also be angled in one or more locations. To the extent that the body portion has a diameter, the diameter of the body portion may stay the same or vary throughout.

The body segment may also have one or more hollow portions in communication with either the first end or second end, or both. For example, the body segment may be a tube, such that a single hollow portion passes through both the first end and the second end. In other embodiments, a first hollow portion in communication with the first end, and may not connect with a second hollow portion of the second end.

The lighting fixture may comprise a first arm and a second arm. The first arm and second arm may be identical or substantially similar to each other except for their orientation in the lighting fixture. The first arm or second arm may be longer or shorter than the other arm. The first arm or second arm may be wider than the other arm. The first arm and second arm may be constructed from a stiff material, such as metal or plastic. The first arm and second arm may be constructed from the same material as the body segment.

The first and second arms may be substantially U-shaped. For example, the first and second arms may have a center portion and one or more flanges extending from the center portion. The flanges may be substantially perpendicular, obtusely angled, or acutely angled with respect to the center portion. The flanges may be of identical length or different lengths. The length of the flange may vary throughout the flange. The flanges may be constructed from the same material as the arms or from a different material. For example, the flanges may be constructed from a translucent, reflective, or diffusive material. The flanges may extend across the entire length of the arm or only a portion of the arm.

One or more lighting components may be mounted on the center portion of the first and second arms. Lighting components may be mounted on the body segment as well. The lighting components may be LEDs or other lighting components known in the art. The lighting components may be arranged evenly unevenly on the center portion. The components may be mounted with adhesive, fasteners, or another means of attachment known in the art. The light emitted from the lighting component may be varied over time with respect to intensity or hue.

The first arm and second arm may be pivotally attached to the body segment such that the first arm and second arm can be positioned to be substantially perpendicular to the body segment and rotate to be substantially parallel to the body segment. For example, the arms may be attached to the body segment using a pin, hinge, or other pivot, such that the arm can pivot around a pivot point. The pivot point may be offset from the body segment. The central portion of the first arm may extend past the first pivot point and the central portion of the second arm may extend past the second pivot point. The flanges may also extend past the pivot points. The one or more hollow portions in the body segment may be substantially covered by the central portion of the first arm that extends past the first pivot point and/or the central portion of the second arm that extends past the second pivot point.

The arms may also be attached to the body segment in other ways, such as fixedly attached or removably attached to the body segment. For example, the arms may be fixedly attached such as being welded into place at a predetermined angle in relation to the body segment. The arms may also be removably attached, such that the arms can be removed from the body segment and attached at the time of installation.

The arms may have additional pivot points to allow additional height to the arms while still folding to a length shorter than the body segment. For example, the each arm may be three times the length of the body segment, but have multiple pivot points such that the arm can fold over itself.

The first arm and second arm may be biased away from being positioned substantially parallel to the body segment. For example, the first arm and second arm may be configured such that the arms will naturally pivot away from the body segment into an open state. The arms may be configured to temporarily attach to the body segment such that, when unattached, the arms will naturally pivot away from the body segment into an open state (i.e., perpendicular or obtusely angled in relation to the body segment). The arms may also be biased such that the arms will remain in the closed state until a force is applied to the arms by the user, at which point, the arms will naturally pivot away from the body segment into an open state. The arms may also be configured to lock when in the open state. The arms may be configured such that a user can unlock the arms to return them into the closed state.

One or more power components may be positioned within the one or more hollow portions of the body segment. The one or more power components may include LED drivers, transformers, and other power-related circuitry. The one or more power components are electrically connected to the one or more lighting components and power source. For example, wires may extend from the power components to one or more of the lighting components on each arm.

The body segment may have one or more apertures in communication with the one or more hollow portions to permit electrical cables to enter the hollow portions of the body segment. The apertures may also be configured to accept mountable devices, such as power switches. For example, the aperture may be configured to allow a switch to be mounted to the body segment.

Each arm may have a cross-member. The cross-member may be manufactured from the same material as each arm or from a different material. The cross-member may be substantially straight, curved, or angled. The cross-member may be configured to be biased such that the cross member exerts force on the housing in which the lighting fixture is placed. The cross-member may be configured to center the lighting fixture within the housing. The first cross-member may be pivotally attached to the central portion of the first arm and the second cross-member may be pivotally attached to the central portion of the second arm. For example, the cross-member can rotate from being substantially parallel to be substantially perpendicular to each arm.

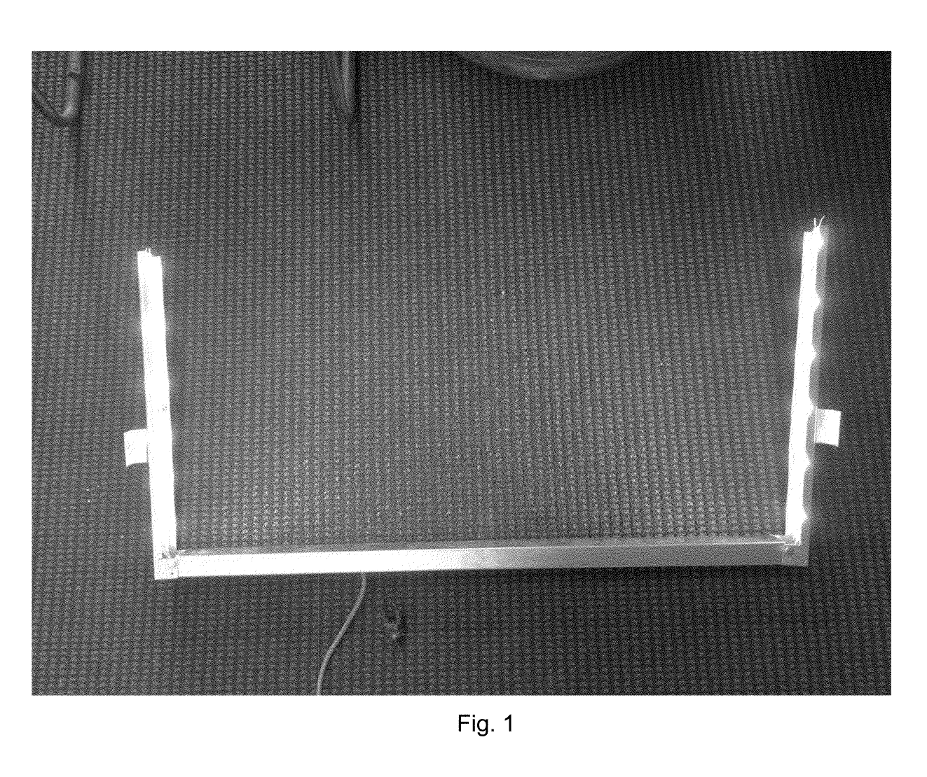

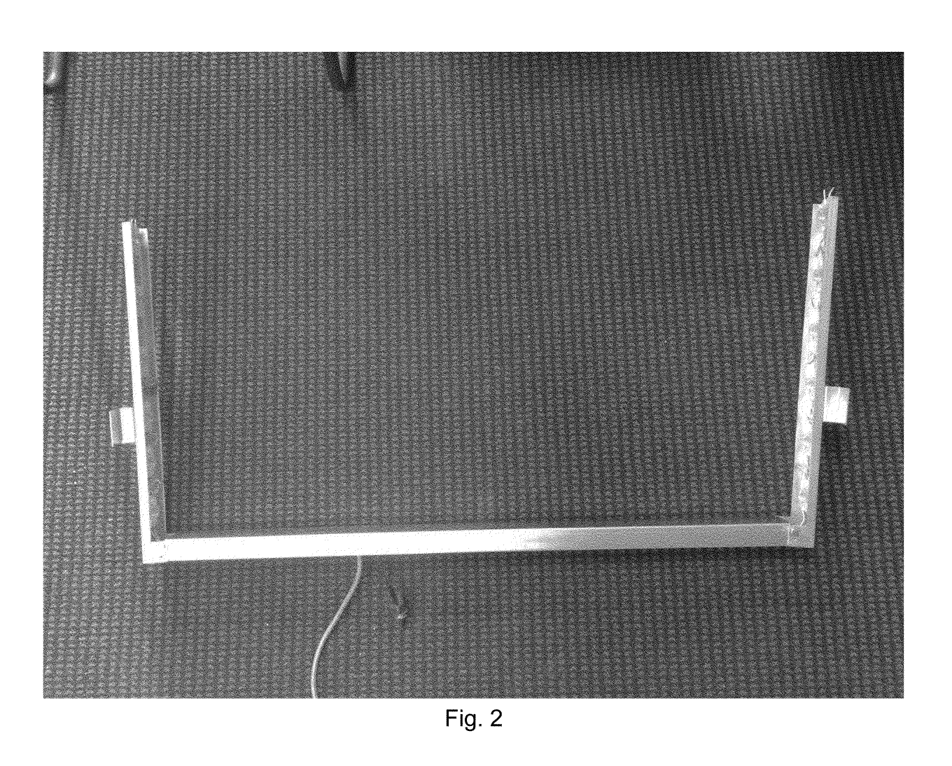

FIG. 1 is a photograph of an exemplary embodiment, wherein the lighting components are energized. As seen in FIG. 1, the first arm and second arm are substantially perpendicular to the body segment. In this embodiment the lighting components are spaced evenly along the first and second arm. FIG. 2 is a photograph of the same embodiment, wherein the lighting components are not energized.

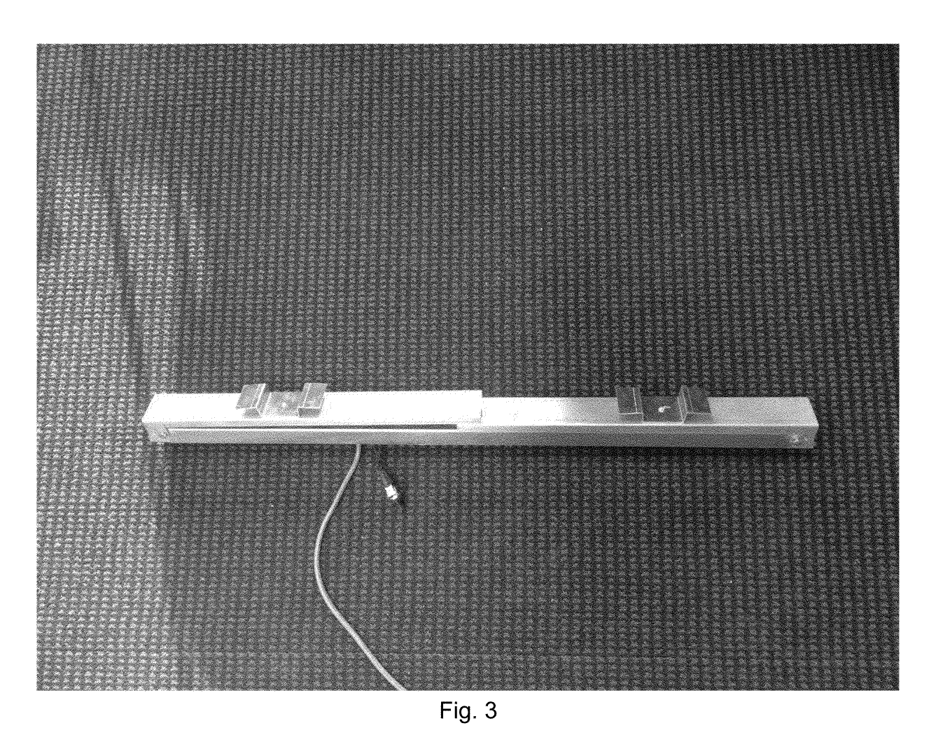

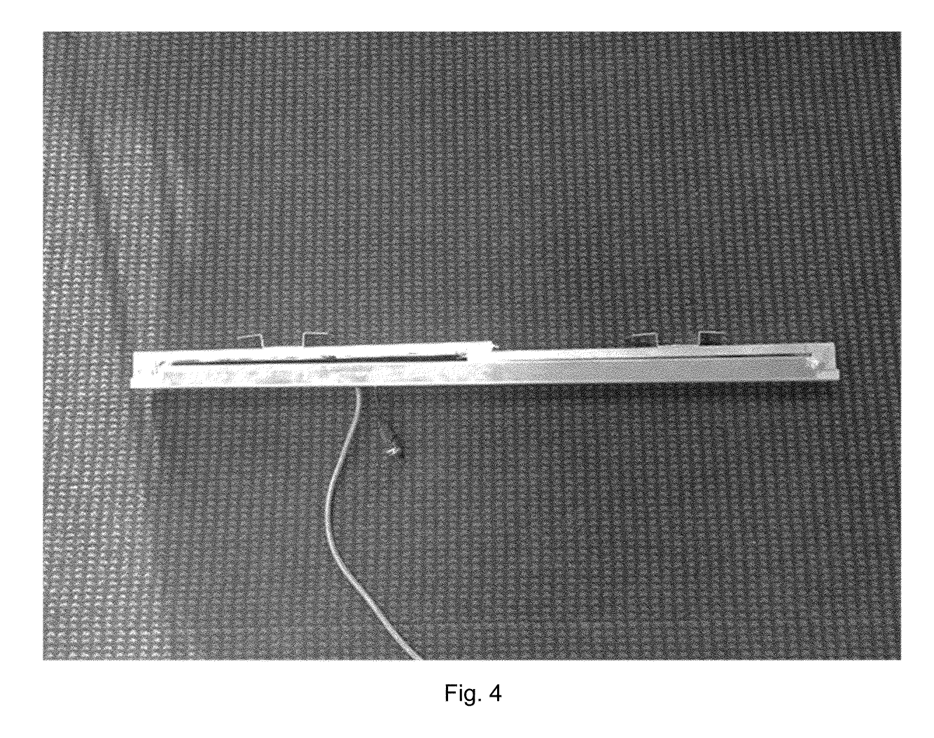

FIG. 3 is a photograph of the same embodiment, wherein the first and second arms are collapsed to be substantially parallel to the body segment. In this embodiment the first arm may overlap with the second arm in a collapsed position. Alternatively, the second arm may overlap the first time. In this embodiment, the cross-members are not biased to be perpendicular to the first arm and second arm. However, a user can rotate the cross-member and the cross-member will stay substantially in place due to friction between the cross-member and the arm. FIG. 4 is a photograph of the same embodiment, wherein the first and second arms are collapsed to be substantially parallel to the body segment, as seen from the side.

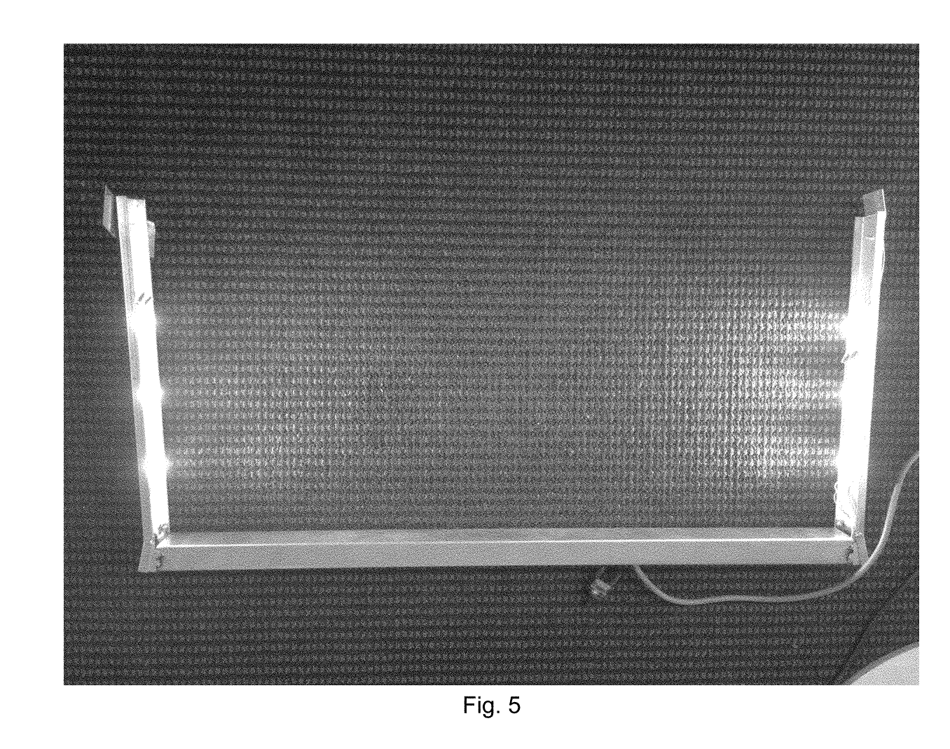

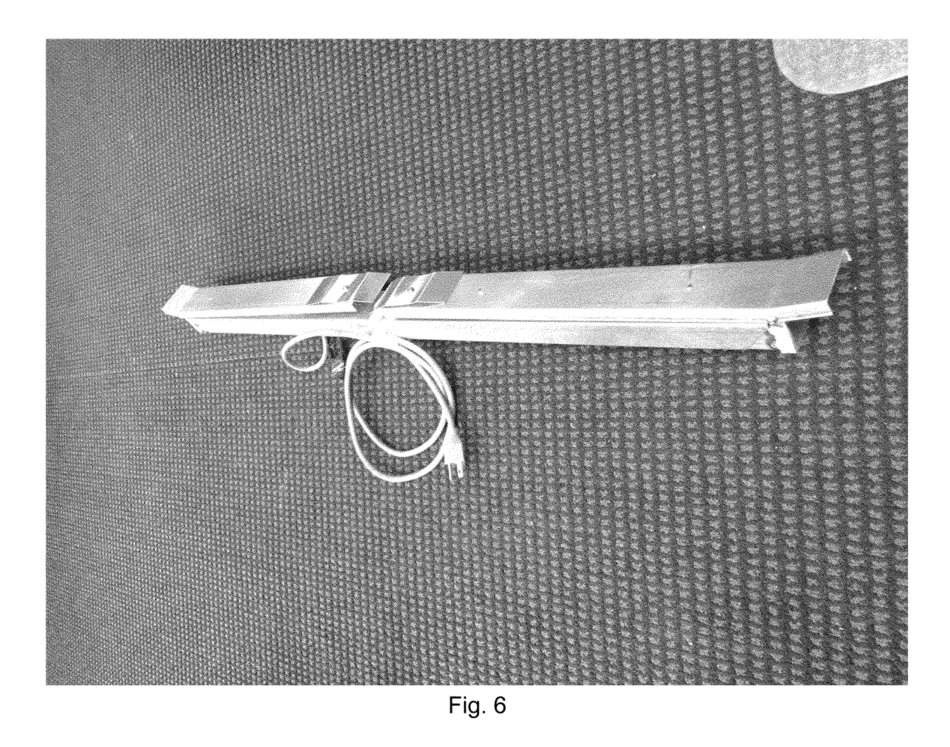

FIG. 5 is a photograph of another embodiment, wherein the lighting components are energized. FIG. 6 is a photograph of the same embodiment, wherein the first and second arms are collapsed to be substantially parallel to the body segment. The second embodiment differs from the first embodiment in that the first arm and the second arm extends beyond the length of the body segment such that, when the arm is perpendicular to the body segment, the extension covers a hollow portion of the body segment.

Although the present disclosure has been described with respect to one or more particular embodiments, it will be understood that other embodiments of the present disclosure may be made without departing from the spirit and scope of the present disclosure.

1. A lighting device comprising:
a body segment having a first end, a second end, the body segment having one or more hollow portions in communication with the first end and/or second end;
a first arm having a center portion and one or more flanges extending from the center portion;
a second arm having a center portion and one or more flanges extending from the center portion; and
one or more lighting components mounted on the center portion of the first arm and/or the center portion of the second arm;
wherein the first arm and second arm are pivotally attached to the body segment such that the first arm and second arm can be positioned to be substantially perpendicular to the body segment and substantially parallel to the body segment.

2. The device of claim 1, wherein one or more power components are positioned within the one or more hollow portions of the body segment such that the power components are in electrical communication with the one or more lighting components.

3. The device of claim 2, wherein the one or more power components are LED drivers.

4. The device of claim 1, wherein the body segment has an aperture configured to permit electrical cables to enter the body segment.

5. The device of claim 1, wherein the hollow portion extends from the first end of the body segment to the second end of the body segment.

6. The device of claim 1, wherein the flanges are configured to reflect light emitted from the one or more lighting components.

7. The device of claim 1, wherein the first arm and second arm are biased away from being substantially parallel to the body segment.

8. The device of claim 1, wherein the first arm and second arm are pivotally attached using a pin.

9. The device of claim 1, wherein the first arm and second arm are pivotally attached using a hinge.

10. The device of claim 1, wherein the first arm and second arm are pivotally attached to the body segment at, respectively, a first and second pivot point.

11. The device of claim 10, wherein the central portion of the first arm extends past the first pivot point and the central portion of the second arm extends past the second pivot point.

12. The device of claim 11, wherein the one or more hollow portions are substantially covered by the central portion of the first arm that extends past the first pivot point and/or the central portion of the second arm that extends past the second pivot point.

13. The device of claim 2, wherein the one or more power components are selectively electrically connected to the one or more lighting components.

14. The device of claim 1, wherein the first arm has a first cross-member and the second arm has a second cross-member.

15. The device of example 14, wherein the first cross-member is pivotally attached to the central portion of the first arm and the second cross-member is pivotally attached to the central portion of the second arm.

16. The device of example 14, wherein the first cross-member and second-cross member are biased to be perpendicular to the central portion of the first arm and second arm.
